(19) United States
(12) Patent Application Publication
(10) Pub. No.: US 2025/0138187 A1
(43) Pub. Date: May 1, 2025

(54) METHOD FOR ADJUSTING ULTRASONIC MEASUREMENT VALUES

(71) Applicant: Robert Bosch GmbH, Stuttgart (DE)

(72) Inventors: Dirk Schmid, Simmozheim (DE); Michael Schumann, Stuttgart (DE)

(21) Appl. No.: 18/903,021

(22) Filed: Oct. 1, 2024

(30) Foreign Application Priority Data
Oct. 31, 2023 (DE) 10 2023 210 767.8

(51) Int. Cl. G01S 15/931

(52) U.S. Cl. CPC G01S 15/931

(57) ABSTRACT

A method for adjusting ultrasonic measurement values. The method includes: ascertaining a reference curve based on an orientation of an ultrasonic sensor element that is configured to output at least one ultrasonic measurement value and based on a ground reference; forming a measurement value curve based on the at least one ultrasonic measurement value; forming a deviation value based on a relationship between the measurement curve and the reference curve for a predetermined period of time; ascertaining a threshold value function based on the deviation value and the reference curve.

### CROSS REFERENCE

The present application claims the benefit under 35 U.S.C. § 119 of German Patent Application No. DE 10 2023 210 767.8 filed on Oct. 31, 2024, which is expressly incorporated herein by reference in its entirety.

### FIELD

The present invention relates to a method for adjusting ultrasonic measurement values, an ultrasonic sensor unit, a computer program, a computer-readable medium, and a vehicle.

### BACKGROUND INFORMATION

There are currently a large number of different solutions for processing ultrasonic measurement values in the automotive sector. Due to the increasing number of ultrasonic sensors in the automotive sector and the increased demands on evaluation quality, the need for innovative and robust methods for evaluating ultrasonic measurement values is steadily growing.

Continuous weight reduction in the automotive sector to reduce consumption and increasing competition are putting pressure on costs, so that there is greater demand for cheaper and more efficient components for vehicles.

### SUMMARY

A method according to the present invention for adjusting ultrasonic measurement values may have the advantage over the related art that the detection sensitivity of ultrasonic sensors can be improved by the adjusted threshold value calculation. Prior knowledge about the course of the received signals can be used to calculate a threshold in order to achieve a better adaptation to the ground. The detection accuracy of ultrasonic sensor elements or ultrasonic sensor units can thus be further improved.

This may be achieved according to an example embodiment of the present invention in that the method for adjusting ultrasonic measurement values comprises the steps:
ascertaining a reference curve based on an orientation of an ultrasonic sensor element that is configured to output at least one ultrasonic measurement value and based on a ground reference,
forming a measurement value curve based on the at least one ultrasonic measurement value,
forming a deviation value based on a relationship between the measurement value curve and based on the reference curve for a predetermined period of time,
ascertaining a threshold value function based on the deviation value and based on the reference curve.

In other words, a threshold value for ultrasonic measurement values is adaptively determined dynamically or time-dependently in order to be able to better evaluate the ultrasonic measurement values. This can in particular be determined depending on the orientation of the ultrasonic sensor element or an installation direction, as well as a ground reference. A vehicle can have a large number of ultrasonic sensor elements, for example, wherein each one of the different ultrasonic sensor elements has a respective orientation, but a predefined ground or ground reference is used to form the reference curve. A measurement curve is also preferably created or produced and/or formed based on a time progression and the ultrasonic measurement values. The deviation value is further preferably set in relation based on the integral of the reference curve and the integral of the measurement value curve, wherein the integrals are in particular formed over the duration of the predetermined period of time. This makes it possible to ascertain a deviation value or delta or the like. The integral of the received signal can, for instance, be divided by the integral of the reference curve at any time in the predetermined period of time in order to in particular be able to form the deviation value from the reference curve. A threshold value function, which is in particular based on the deviation value and the reference curve, is ascertained as well.

Preferred further developments of the present invention are disclosed herein.

According to an example embodiment of the present invention, the method further preferably comprises the step:
ascertaining an output value based on the ascertained threshold value function and based on the at least one ultrasonic measurement value.

An advantage of this embodiment is that the output value of the ultrasonic measurement value can be improved by means of the method, so that a more accurate detection or higher quality ultrasonic measurement value signal can be output.

According to an example embodiment of the present invention, the method further preferably comprises the steps:
adjusting the deviation value to form a filtered deviation value, wherein the filtered deviation value is free of values in a predetermined range,
ascertaining the threshold value function based on the filtered deviation value and based on the reference curve.

An advantage of this embodiment is that the adjustment of the deviation value can be used to compensate the stochastic nature of the received signal by filtering or smoothing the deviation value. This further improves the threshold value calculation.

According to an example embodiment of the present invention, the method further preferably comprises the steps:
receiving and/or selecting a parameter set for setting a sensitivity,
ascertaining the threshold value function based on the filtered deviation value, the reference curve and based on the parameter set.

An advantage of this embodiment is that the sensitivity can be used to react to a respective environmental or application scenario in order to thus further improve the calculation of the threshold value function.

According to an example embodiment of the present invention, the method preferably further comprises the steps:
determining a change in the filtered deviation value in the predetermined period of time,
comparing the change in the filtered deviation value with the reference curve to ascertain an echo in the ultrasonic value,
adjusting the filtered deviation value to eliminate the echo in the filtered deviation value.

An advantage of this embodiment is that, if the change in the filtered deviation values reveals jumps or abnormalities or artifacts, these can be classified as an echo of the ultrasonic value in order to then exclude or eliminate them in the filtered deviation value. The threshold value calculation is thus freed of any echoes in the ultrasonic value or ultrasonic data set.

According to an example embodiment of the present invention, the method further preferably comprises the steps:
ascertaining a signal-to-interference ratio in the measurement value curve,
adjusting the threshold value function if the signal-to-interference ratio exceeds a predetermined limit value.

An advantage of this embodiment is that high sensor noise caused by external acoustic sources or electromagnetic interference can be calculated out of the measurement value curve in order to thus be able to further improve the model prediction by means of the threshold value. A signal-to-interference ratio can be determined at the beginning, for example, and/or a signal-to-noise ratio can be adopted from a previous measurement.

According to an example embodiment of the present invention, the method further preferably comprises the steps:
acquiring and/or selecting an environmental parameter of the ultrasonic sensor element,
adjusting the reference curve based on the environmental parameter.

An advantage of this embodiment is that the calculation of the threshold value function to possible environmental parameters such as the air temperature and the humidity or the like, which can have an influence on the airborne sound absorption of the ultrasonic signal, can be taken into account in the calculation of the threshold value. This makes it possible to further increase the stability of the threshold value calculation.

According to an example embodiment of the present invention, the method further preferably comprises the steps:
initiating the deviation value based on an initiation value, wherein the initiation value is a measurement value outside the predetermined period of time and/or the initiation value is a historical value of a previous measurement.

An advantage of this embodiment is that the calculation of the threshold value function is shortened because an integration time of the correction factor is shortened by initiating the deviation value using an initiation value. A previous measurement or a predetermined value can thus be used to steer the deviation value in the right direction.

According to an example embodiment of the present invention, the predetermined period of time further preferably includes a first limit value and a second limit value, wherein the method further comprises the step:
adjusting the predetermined period of time for a time range between the first limit value and the second limit value.

An advantage of this embodiment is that the predetermined period of time in which the received signal or the measurement value curve and the reference curve are integrated can be continuously adjusted. For example, an evaluation window is defined, which is defined as a predetermined period of time and has a value to the left and a value to the right of a currently considered point in time that can be up to +/−6 ms, for instance. The integral can thus be formed over this period of time via the measurement value curve and via the reference curve in order to be able to ascertain the deviation value.

According to an example embodiment of the present invention, the predetermined period of time further preferably includes a reference and a third limit value, wherein the method further comprises a step:
forming the predetermined period of time between the reference and the third limit value.

An advantage of this embodiment is that the predetermined period of time can be significantly increased because the predetermined period of time is a continuously growing window. The measurement value curve and the reference curve can thus be integrated between a starting point and a current time range plus a delta, such as one millisecond, in order to be able to calculate the deviation value.

Another aspect of the present invention relates to an ultrasonic sensor unit which is configured to acquire at least one ultrasonic measurement value and is configured to carry out steps of the method of the present invention as described above and in the following.

Another aspect of the present invention relates to a computer program which is configured to carry out steps of the method of the present invention as described above and in the following.

Another aspect of the present invention relates to a computer-readable medium which stores the computer program as described above and in the following.

Another aspect of the present invention relates to a vehicle which comprises the ultrasonic sensor unit of the present invention as described above and in the following and/or is configured to carry out steps of the method of the present invention as described above and in the following.

### BRIEF DESCRIPTION OF THE DRAWINGS

Embodiment examples of the present invention are described in detail in the following with reference to the figures.

FIGS. 1 and 2 each show a flow chart to illustrate steps of the method according to one example embodiment of the present invention.

FIG. 3 shows an ultrasonic sensor unit.

FIG. 4 shows a vehicle.

FIG. 5 shows graph to illustrate the steps of the method according to one example embodiment of the present invention.

### DETAILED DESCRIPTION OF EXAMPLE EMBODIMENTS

All same components, elements, and/or units are preferably provided with the same reference signs in all of the figures.

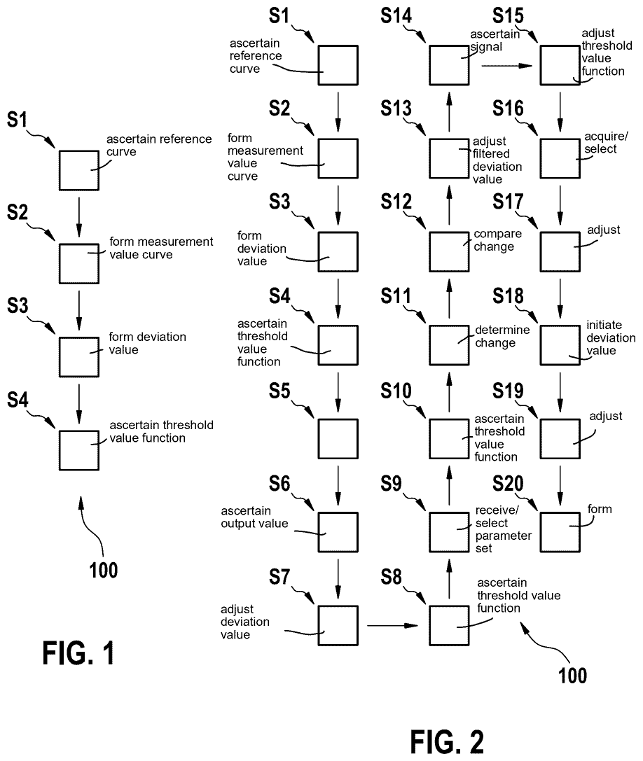

FIG. 1 shows a flow chart to illustrate steps of the method 100 according to one embodiment. The method 100 for adjusting ultrasonic measurement values preferably comprises the steps:
ascertaining S1 a reference curve based on an orientation 204 of an ultrasonic sensor element 202 that is configured to output at least one ultrasonic measurement value and based on a ground reference,
forming S2 a measurement value curve based on the at least one ultrasonic measurement value,
forming S3 a deviation value based on a relationship between the measurement value curve and the reference curve for a predetermined period of time, ascertaining S4 a threshold value function based on the deviation value and based on the reference curve.

FIG. 2 shows a flow chart to illustrate steps of the method 100 according to one embodiment. The method 100 in FIG. 2 has the same steps S1 to S4 as have already explained with respect to FIG. 1. The method 100 further preferably comprises the step ascertaining S6 an output value. The method 100 preferably comprises the step adjusting S7 the deviation value and ascertaining S8 the threshold value function. The method 100 also preferably comprises the steps receiving and/or selecting S9 a parameter set and ascertaining S10 the threshold value function.

The method 100 further preferably comprises the steps determining S11 a change, comparing S12 the change and adjusting S13 the filtered deviation value. The method 100 preferably comprises the steps ascertaining S14 a signal and adjusting S15 the threshold value function. The method 100 also preferably comprises the steps acquiring and/or selecting S16 and adjusting S17. The method 100 preferably comprises the step initiating S18 the deviation value.

The method 100 further preferably comprises the step adjusting S19. The method preferably comprises the step forming S20.

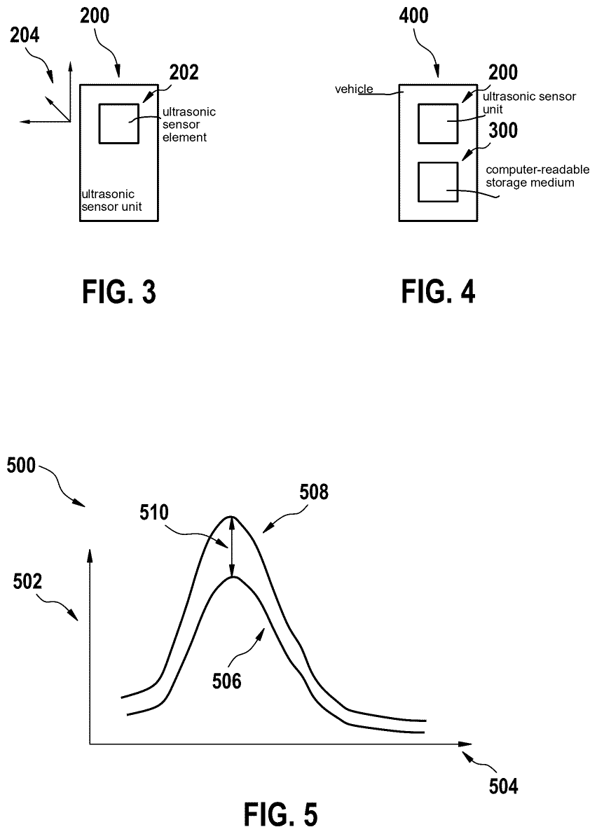

FIG. 3 shows a sensor unit 200 according to one embodiment. The ultrasonic sensor unit 200 is configured to acquire at least one ultrasonic measurement value. The ultrasonic sensor unit 200 further preferably comprises an ultrasonic sensor element 202 which is configured to output an ultrasonic measurement value. The ultrasonic sensor element 202 is further preferably disposed in a predefined orientation 204 which is known to the ultrasonic sensor unit 200. The sensor unit 200 is further preferably configured to carry out steps of the method 100 as above and in the following.

FIG. 4 shows a vehicle 400 according to one embodiment. The vehicle 400 is configured to carry out steps of the method 100 as described above and in the following. The vehicle 400 further preferably comprises an ultrasonic sensor unit 200 as described above and in the following. The vehicle 400 also preferably comprises a computer-readable storage medium 300 which stores the computer program as described above and in the following.

FIG. 5 shows a graph 500 according to an embodiment to illustrate the method 100. The graph 500 has a first axis 502 that shows measurement values. The graph 500 further preferably has a second axis 504 that shows the time progression. A data curve or reference curve 506 is further preferably shown in the graph 500. A measurement value curve 508 is preferably shown in the graph 500 as well. A threshold value function 510 can be ascertained based on the relationship between the reference curve 506 and the measurement value curve 508.

Certain embodiments of the present invention are provided below in the numbered examples.

Example 1. Method (100) for adjusting ultrasonic measurement values, comprising the steps:
ascertaining (S1) a reference curve based on an orientation (204) of an ultrasonic sensor element (202) that is configured to output at least one ultrasonic measurement value and based on a ground reference,
forming (S2) a measurement value curve based on the at least one ultrasonic measurement value,
forming (S3) a deviation value based on a relationship between the measurement curve and the reference curve for a predetermined period of time,
ascertaining (S4) a threshold value function based on the deviation value and the reference curve.

Example 2. Method (100) according to Example 1, further comprising the steps:
ascertaining (S6) an output value based on the ascertained threshold value function and based on the at least one ultrasonic measurement value.

Example 3. Method (100) according to one of the preceding numbered examples, further comprising the steps:
adjusting (S7) the deviation value to form a filtered deviation value, wherein the filtered deviation value is free of values in a predetermined range,
ascertaining (S8) the threshold value function based on the filtered deviation value and based on the reference curve.

Example 4. Method (100) according to Example 3, further comprising the steps:
receiving and/or selecting (S9) a parameter set for setting a sensitivity,
ascertaining (S10) the threshold value function based on the filtered deviation value, the reference curve and based on the parameter set.

Example 5. Method (100) according to one of Examples 3 to 4, further comprising the steps:
determining (S11) a change in the filtered deviation value in the predetermined period of time,
comparing (S12) the change in the filtered deviation value with the reference curve to ascertain an echo in the ultrasonic value,
adjusting (S13) the filtered deviation value to eliminate the echo in the filtered deviation value.

Example. Method (100) according to one of the preceding numbered examples, further comprising the steps:
ascertaining (S14) a signal-to-interference ratio in the measurement value curve,
adjusting (S15) the threshold value function if the signal-to-interference ratio exceeds a predetermined limit value.

Example 7. Method (100) according to one of the preceding numbered examples, further comprising the steps:
acquiring and/or selecting (S16) an environmental parameter of the ultrasonic sensor element (202),
adjusting (S17) the reference curve based on the environmental parameter.

Example 8. Method (100) according to one of the preceding numbered examples, further comprising the step:
initiating (S18) the deviation value based on an initiation value, wherein the initiation value is a measurement value outside the predetermined period of time and/or the initiation value is a historical value of a previous measurement.

Example 9. Method (100) according to one of the preceding numbered examples, wherein the predetermined period of time includes a first limit value and a second limit value, further comprising the step:
adjusting (S19) the predetermined period of time for a time range between the first limit value and the second limit value.

Example 10. Method (100) according to one of Examples 1 to 8, wherein the predetermined period of time includes a reference and a third limit value, further comprising the step:
forming (S20) the predetermined period of time between the reference and the third limit value.

Example 11. Ultrasonic sensor unit (200), which is configured to acquire at least one ultrasonic measurement value and is configured to carry out steps of the Method according to one of Examples 1 to 10.

Example 12. Computer program, which is configured to carry out steps of the method according to one of Examples 1 to 10.

Example 13. Computer-readable storage medium on which the computer program according to Example 12 is stored.

Example 14. Vehicle (400) comprising an ultrasonic sensor unit (200) according to Example 1 and/or configured to carry out the method according to one of Examples 1 to 10.

What is claimed is:

1. A method for adjusting ultrasonic measurement values, comprising the following steps:
ascertaining a reference curve based on an orientation of an ultrasonic sensor element that is configured to output at least one ultrasonic measurement value and based on a ground reference;
forming a measurement value curve based on the at least one ultrasonic measurement value;
forming a deviation value based on a relationship between the measurement curve and the reference curve for a predetermined period of time; and
ascertaining a threshold value function based on the deviation value and the reference curve.

2. The method according to claim 1, further comprising the step:
ascertaining an output value based on the ascertained threshold value function and based on the at least one ultrasonic measurement value.

3. The method according to claim 1, further comprising the following steps:
adjusting the deviation value to form a filtered deviation value, wherein the filtered deviation value is free of values in a predetermined range; and
ascertaining the threshold value function based on the filtered deviation value and based on the reference curve.

4. The method according to claim 3, further comprising the following steps:
receiving and/or selecting a parameter set for setting a sensitivity; and
ascertaining the threshold value function based on the filtered deviation value, the reference curve, and based on the parameter set.

5. The method according to claim 3, further comprising the following steps:
determining a change in the filtered deviation value in the predetermined period of time;
comparing the change in the filtered deviation value with the reference curve to ascertain an echo in the ultrasonic value; and
adjusting the filtered deviation value to eliminate the echo in the filtered deviation value.

6. The method according to claim 1, further comprising the following steps:
ascertaining a signal-to-interference ratio in the measurement value curve; and
adjusting the threshold value function when the signal-to-interference ratio exceeds a predetermined limit value.

7. The method according to claim 1, further comprising the following steps:
acquiring and/or selecting an environmental parameter of the ultrasonic sensor element; and
adjusting the reference curve based on the environmental parameter.

8. The method according to claim 1, further comprising the step:
initiating the deviation value based on an initiation value, wherein the initiation value is a measurement value outside the predetermined period of time and/or the initiation value is a historical value of a previous measurement.

9. The method according to claim 1, wherein the predetermined period of time includes a first limit value and a second limit value, and the method further comprises the following step:
adjusting the predetermined period of time for a time range between the first limit value and the second limit value.

10. The method according to claim 1, wherein the predetermined period of time includes a reference and a third limit value, and the method further comprises the following step:
forming the predetermined period of time between the reference and the third limit value.

11. An ultrasonic sensor unit, which is configured to acquire at least one ultrasonic measurement value and is configured to adjust ultrasonic measurement values, the ultrasonic sensor unit configured to:
ascertain a reference curve based on an orientation of an ultrasonic sensor element that is configured to output at least one ultrasonic measurement value and based on a ground reference;
form a measurement value curve based on the at least one ultrasonic measurement value;
form a deviation value based on a relationship between the measurement curve and the reference curve for a predetermined period of time; and
ascertain a threshold value function based on the deviation value and the reference curve.

12. A non-transitory computer-readable storage medium on which is stored a computer program adjusting ultrasonic measurement values, the computer program, when executed by a computer, causing the computer to perform the following steps:
ascertaining a reference curve based on an orientation of an ultrasonic sensor element that is configured to output at least one ultrasonic measurement value and based on a ground reference;
forming a measurement value curve based on the at least one ultrasonic measurement value;
forming a deviation value based on a relationship between the measurement curve and the reference curve for a predetermined period of time; and
ascertaining a threshold value function based on the deviation value and the reference curve.

13. A vehicle, comprising:
an ultrasonic sensor unit which is configured to acquire at least one ultrasonic measurement value and is configured to adjust ultrasonic measurement values, the ultrasonic sensor unit configured to:
ascertain a reference curve based on an orientation of an ultrasonic sensor element that is configured to output at least one ultrasonic measurement value and based on a ground reference;
form a measurement value curve based on the at least one ultrasonic measurement value;
form a deviation value based on a relationship between the measurement curve and the reference curve for a predetermined period of time; and
ascertain a threshold value function based on the deviation value and the reference curve.
